(19) United States
(12) Patent Application Publication
(10) Pub. No.: US 2014/0279683 A1
(43) Pub. Date: Sep. 18, 2014

(54) Performance Evaluation Of Mortgage Portfolios

(71) Applicant: James D. Campbell, Dallas, TX (US)

(72) Inventor: James D. Campbell, Dallas, TX (US)

(21) Appl. No.: 13/836,188

(22) Filed: Mar. 15, 2013

(51) Int. Cl. G06Q 40/06

(52) U.S. Cl. CPC G06Q 40/06
USPC 705/36 R

(57) ABSTRACT

Systems and methods for mortgage portfolio evaluation are provided. Some embodiments of the present invention use a synthetic pool model as part of the process for evaluating and pricing mortgage servicing rights (MSR). In some embodiments, the synthetic pool model can identify a static pool of loans from the servicing portfolio (e.g., portfolio of residential mortgages) with collateral characteristics similar to the loans in the bid pool. Performance reports can then be created from the synthetic pool in order to estimate the performance of the loan servicer based on actual historical performance of a portfolio with similar characteristics. In addition, these reports can quantify performance assumptions for use in an MSR pricing model.

### TECHNICAL FIELD

Various embodiments of the present invention generally relate to systems and methods for investment analysis. In particular, some embodiments of the present invention relate to systems and methods for evaluating the performance of mortgage portfolios.

### BACKGROUND

Most individuals need to borrow money for the purchase of a home. This type of loan is generally referred to as a mortgage loan (or mortgage) and is typically secured by the real property. There are many types of mortgages, but two primary categories include the adjustable-rate mortgage and the fixed rate mortgage. Adjustable rate mortgages have variable interest rates that can change at certain points over the course of the loan. In contrast, fixed rate mortgages have a fixed rate for the life of the loan. In addition to the type of interest rate, mortgage loans generally have a maximum term after which the loan will be or must be repaid. The amount of the payments will depend on the original amount of the loan, the interest rate, the term, and other characteristics. The payment amount may change over time (e.g., in the case of an adjustable rate mortgage) or the borrower may have the option to increase or decrease the amount paid.

The financial institutions making the loans often sell the servicing rights (i.e., the mortgage servicing rights) to loan servicers who collect payments and otherwise manage the mortgage loans. Different loan servicers may provide slightly different services and have different levels of expertise. For example, some servicers may be more skilled in negotiating modifications and workout plans for distressed borrows. In exchange for the services provided, the loan servicer receives compensation from the lender. Traditionally, financial institutions and investors have had difficulty in effectively evaluating the servicers due to the static pricing models based on historical performance of the loan servicers. As such, the static pricing models used for determining compensation and the random manners of evaluating loan servicers create challenges in properly matching mortgage lenders and loan services.

### SUMMARY

Systems and methods are described for evaluating performance of mortgage portfolios. Some embodiments provide for a method that includes receiving a request to analyze a mortgage portfolio having a plurality of mortgages serviced by a first loan servicer. A set of loan characteristics of the mortgage portfolio can be identified. Then, based at least in part on the loan characteristics, a synthetic pool of mortgages can be created by selecting mortgages that are being serviced by a second loan servicer that have a similar set of characteristics. The synthetic pool of mortgages can then be analyzed to predict how the second servicer would have performed.

In order to ensure that the synthetic pool of mortgages properly matches characteristics of the mortgage portfolio, the mortgages in the bid pool may be restricted to those that were active during a specified time period. In addition, the sample size of the synthetic mortgage pool can be evaluated to ensure that the quantity and/or distribution of loan characteristics are similar between the mortgage portfolio and the synthetic pool. For example, value groupings of the mortgage portfolio and/or the synthetic pool can be created and compared. The grouping may be based on unpaid principle balance, current property value or current loan-to-value.

Embodiments of the present invention also include computer-readable storage media containing sets of instructions to cause one or more processors to perform the methods, variations of the methods, and other operations described herein.

Various embodiments of the present invention can include an evaluation system with a processor, a historical servicing database, an importation module, a characteristics module, a synthetic pool selection module, a report module, a grouping module, an evaluation module, and/or other modules or components. The historical servicing database can include information regarding a first plurality of loan mortgages serviced by a loan servicer. The importation module can be configured to receive bid data regarding a second plurality of loan mortgages which a user or investor would like to understand how effectively the loan servicer could manage. The characteristics module accesses the bid data and identifies a set of loan characteristics which are descriptive of various features of the second plurality of loan mortgages.

The synthetic pool selection module receives the set of identified loan characteristics and creates (e.g., using the processor) a synthetic pool of loan mortgages by selecting a subset of the first plurality of loan mortgages similar to the second plurality of loan mortgages as defined by the loan characteristics identified by the characteristics module. The report module can then generate an analysis of the synthetic pool to predict how effectively the loan servicer manages mortgage portfolios like the second plurality of loan mortgages supplied by the user or investor.

In some cases, the synthetic pool selection module can use the grouping module to create subsets of the second plurality of loan mortgages based on an identified set of mortgage characteristics. The evaluation module can determine if the synthetic pool created by the synthetic pool selection module sufficiently matches the loan characteristics. If not, a request can be sent to the synthetic pool selection module to refine, update, or otherwise improve the synthetic pool so that the loan characteristics of the synthetic pool better match the loan characteristics of the second plurality of loan mortgages. The graphical user interface (GUI) generation module configured to generate a graphical user interface screens to interact with the user and/or present information such as the analysis generated by the report module.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present invention will be described and explained through the use of the accompanying drawings in which:

FIG. 1 illustrates an example of a network-based environment in which some embodiments of the present invention may be utilized;

FIG. 2 illustrates components of a synthetic pool analyzer in accordance with one or more embodiments of the present invention;

FIGS. 3-7 illustrates examples of portions of reports which may be generated in accordance with various embodiments of the present invention;

FIG. 8 is a flowchart illustrating a set of operations for generating synthetic pool analysis in accordance with various embodiments of the present invention;

FIG. 9 is a flowchart illustrating a set of operations for pricing servicing rights in accordance with some embodiments of the present invention;

FIG. 10 is a flowchart illustrating a set of operations for generating strategies and performance reports in accordance with some embodiments of the present invention;

FIG. 11 is a sequence diagram illustrating an example of the data flow between various components of a service performance analysis system in accordance with various embodiments of the present invention; and

FIG. 12 illustrates an example of a computer system with which some embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Systems and methods for investment analysis are described. In particular, various embodiments of the present invention relate to systems and methods for providing performance evaluations and comparisons of mortgage portfolios. These techniques provide a historically-based prediction on how a mortgage portfolio owned by an investor (e.g., bank, hedge fund, pension fund, etc.) would perform if the portfolio was managed by a different mortgage servicer. Historically, when investors were evaluating the performance of mortgage servicers, the investors could only evaluate and compare the entire performance of the servicers. However, servicers may be more effective in managing portfolios with certain types of characteristics than portfolios with other types of characteristics. For example, some servicers may be better than others at working with distressed borrowers and creating effective workout arrangements. As such, this traditional evaluation of the servicer made it difficult to predict how a loan service would perform on a portfolio with particular characteristics.

Some embodiments of the present invention use a synthetic pool model as part of the process for evaluating and pricing MSR. For example, the model can identify a static pool of loans from the servicing portfolio (e.g., portfolio of residential mortgages) with collateral characteristics similar to the loans in the bid pool. Performance reports can then be created from the synthetic pool in order to estimate the performance of the loan servicer based on actual performance of a portfolio with similar characteristics. In addition, these reports can quantify performance assumptions for use in the MSR pricing model.

In some cases, an investor can submit loan level bid data. This data can be stored, (e.g., in an SQL Server database). The loan level bid data can include one or more of the following data points: lien position; current unpaid principal balance (UPB); current property value; current loan-to-value (LTV); current delinquency status; current interest rate; product type (Fixed/ARM); property state; property zip code; occupancy type; property type; and or other information. Using the loan level bid data, a synthetic loan pool can be selected from loans that are being serviced by a provider. The basis (e.g., the servicers loan pool) for the synthetic loan pool can include all active residential loans serviced within a specified time period (e.g., thirteen months prior to the latest month end when bid is priced). Various techniques can be used to generate the synthetic loan pool including optimization techniques, group-based matching, and others.

While, for convenience, embodiments of the present invention are described with reference to servicing rights of residential mortgage portfolios, other embodiments of the present invention are equally applicable to various other operational models, including servicing rights for other types of loans and financial instruments. In addition, the synthetic pool model of many embodiments may be accessed by users using a software package or hardware device (with associated software or firmware) which may be directly installed on or connected to an end user's computer and used to interact with the signal transmission and distribution networks.

Moreover, the techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

### TERMINOLOGY

Brief definitions of terms used throughout this application and attached Appendix are given below.

The terms “connected” or “coupled” and related terms are used in an operational sense and are not necessarily limited to a direct connection or coupling.

The term “embodiments,” phrases such as “in one embodiment,” and the like, generally mean the particular feature(s), structure(s), method(s), or characteristic(s) following or preceding the term or phrase is included in at least one embodiment of the present invention, and may be included in more than one embodiment of the present invention. In addition, such terms or phrases do not necessarily refer to the same embodiments.

If the specification states a component or feature “may”, “can”, “could”, or “might” be included or have a characteristic, that particular component or feature is not required to be included or have the characteristic.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, and/or a module can include one or more application programs.

The term “responsive” includes completely and partially responsive.

### GENERAL DESCRIPTION

FIG. 1 illustrates an example of network-based environment 100 in which some embodiments of the present invention may be utilized. As illustrated in FIG. 1, network-based environment 100 may include various graphical user interfaces running on one or more points of interaction 110a-n (such as a mobile device, a mobile phone, a tablet computer, a mobile media device, etc.). These points of interaction can present graphical user interfaces for analyzing mortgage portfolio servicing by connecting through network 115 to synthetic pool analyzer 120. Bid data regarding the mortgage portfolio may be submitted through the points of interactions and stored on bid database 125. Comparative portfolio data may be stored in servicer database 130. Synthetic pool analyzer 120 can access the bid data and generate a synthetic portfolio which similar characteristics from the comparative portfolio data.

Points of interaction 110a-n can include network communication components that enable the points of interaction to communicate with network 115 or other electronic devices by transmitting and receiving wireless signals using licensed, semi-licensed or unlicensed spectrum over network 115. In some cases, network 115 may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. Network 115 can also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), or other communications network.

FIG. 2 illustrates components of synthetic pool analyzer 120 in accordance with one or more embodiments of the present invention. According to the embodiments shown in FIG. 2, synthetic pool analyzer 120 can include memory 205, one or more processors 210, importation module 215, selection module 220, characteristics module 225, grouping module 230, synthetic pool selection module 235, evaluation module 240, report module 245, and graphical user interface (GUI) generation module 250. Other embodiments of the present invention may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, selection module 220, characteristics module 225, and grouping module 230 can be combined into a single module for identifying characteristics of the bid mortgage portfolio.

Memory 205 can be any device, mechanism, or populated data structure used for storing information. In accordance with some embodiments of the present invention, memory 205 can encompass any type of, but is not limited to, volatile memory, nonvolatile memory and dynamic memory. For example, memory 205 can be random access memory, memory storage devices, optical memory devices, media magnetic media, floppy disks, magnetic tapes, hard drives, SDRAM, RDRAM, DDR RAM, erasable programmable read-only memories (EPROMs), electrically erasable programmable read-only memories (EEPROMs), compact disks, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 205.

Memory 205 may be used to store instructions for running one or more applications or modules on processor(s) 210. For example, memory 205 could be used in one or more embodiments to house all or some of the instructions needed to execute the functionality of importation module 215, selection module 220, characteristics module 225, grouping module 230, synthetic pool selection module 235, evaluation module 240, report module 245, or GUI generation module 250.

Importation module 215 can receive or import bid data regarding loans for evaluation. For example, in some embodiments, the bid data can be received or imported from a database, cloud storage platform, or other storage device. The bid data can include specific information about the loan, including, but not limited to, lien position, current unpaid principal balance (UPB), current property value, current loan-to-value (LTV), current delinquency status, current interest rate, product type (Fixed/ARM), property state, property zip code, occupancy type (e.g., owner occupied), property type, payment history, delinquency information, borrower information (e.g., occupation, age, credit score, etc.), and/or other information.

Selection module 220 can receive a selection from a user to price the mortgage servicing rights on a set of loans. Selection module 220, for example, may use GUI generation module 250 to generate a graphical user interface screen that allows for the submission of loan bid data over a network. The graphical user interface screen may also include one or more filters allowing the user to evaluate subsets of the set of loans against different service providers. For example, in order to evaluate multiple loan servicers, the graphical user interface may present recommended (or pre-defined) filters that select portions of the set of loans based on strengths of the service provider. In other cases, the service providers may require specific portfolio profiles. Selection module 220 can evaluate the loan portfolio to ensure that any service provider requirements are satisfied.

Characteristics module 225 can be configured to access or retrieve the bid data and identify a set of loan characteristics. The loan characteristics can be characteristics of the set of loans that were selected by the user (e.g., through a graphical user interface), default characteristics recommended by a loan servicer, or a dynamically selected set of characteristics based on a loan servicer's portfolio. The loan characteristics can be used to generate the synthetic loan pool. In some embodiments, grouping module 230 can create or identify subsets (or groups) of the loan mortgages based on mortgage characteristics. The different groups can be used to generate multiple reports emphasizing the characteristics of a certain portfolio composition. Users of the system might find the multiple reports emphasizing different characteristics useful in evaluating a service provider if the user (e.g., investor) expects that a current portfolio composition would shift over time.

Synthetic pool selection module 235 receives the set of loan characteristics and creates a synthetic pool of loan mortgages. In some embodiments, the synthetic pool of loan mortgages may be created by selecting a subset of loan mortgages from the service provider similar to the loan mortgages held by the investor. In various embodiments, the similarity or closeness of the two sets of loan mortgages can be defined by the loan characteristics identified by the characteristics module. Various automated techniques such as optimization algorithms may also be used to create the synthetic pool. Once a synthetic pool is generated, evaluation module 240 can determine if the synthetic pool created by synthetic pool selection module 235 sufficiently matches the loan characteristics.

A statistical summary may be reported to the user, in some embodiments. FIG. 3 illustrates an example of a report generated by report module 245 showing the statistical comparison of the characteristics. Report module 245 can also generate other types of reports and/or summaries. Examples of portions of some of the types of reports that can be generated are illustrated in FIGS. 4-7. For example, report module 245 can generate an asset outcome report that stratifies the loan resolutions of the synthetic pool for a selected or predefined period (e.g., a twelve month period ending with the most recent month end, the previous three calendar years, etc.). A synthetic pool report (see, e.g., FIG. 4) that stratifies the lien position can be generated by report module 245. An asset report (see, e.g., FIG. 5) that stratifies the asset outcome of the synthetic pool can be generated in some embodiments. A modifications report (see, e.g., FIG. 6) can also be generated that stratifies the volume and type of modifications completed in the synthetic pool over the selected period as well as the post-modification performance through the most recent month end. In some embodiments, report module 245 can generate a delinquency report (see, e.g., FIG. 7) that stratifies the monthly delinquency rates for the synthetic pool and provides roll rates over the selected period. In addition, a borrower behavior report can be generated that stratifies borrower behavioral characteristics (e.g., average days paid, debt utilization, FICO drift, etc.) in the synthetic pool.

GUI generation module 250 can generate one or more GUI screens that allow for interaction with a user. In at least one embodiment, GUI generation module 250 generates a graphical user interface allowing a user to view statistical reports, account information, various summaries, select loan servicers, set preferences, and/or otherwise receive or convey information to the user.

FIG. 8 is a flowchart illustrating a set of operations 800 for generating synthetic pool analysis in accordance with various embodiments of the present invention. The operations illustrated in FIG. 8 may be performed by one or more components or modules such as processor(s) 210, characteristics module 225, grouping module 230, synthetic pool selection module 235, evaluation module 240, and/or components or modules. During receiving operation 810 loan level bid data can be received. The bid data includes historical servicing data and informative data regarding servicing of a mortgage portfolio. Once received, identification operation 820 can identify the composition of the mortgage portfolio. For example, characteristics such as lien position, property type, average balance, current unpaid principle, current property value, current loan-to-value, current delinquency status, current interest rates on the mortgages, product types (e.g., fixed rates vs. adjustable rates), property state, property zip code, occupancy type, property type, and/or other descriptive information.

Once the portfolio composition has been identified, determination operation 830 can determine a synthetic pool of mortgages from an alternative portfolio servicer that has a similar composition. In accordance with various embodiments, different compositional characteristics may be selected, emphasized, or deemphasized. Still yet, in some cases, multiple synthetic pools may be generated that match different characteristics or from different loan servicers. Using the synthetic pool, historical performance data relating to the servicing of the synthetic pool can be analyzed and compared to the actual bid data received during analysis operation 840. In some cases, the comparison may be only over a specified period of time (e.g., the last thirteen months).

FIG. 9 is a flowchart illustrating a set of operations 900 for pricing servicing rights in accordance with some embodiments of the present invention. The operations illustrated in FIG. 9 may be performed by one or more components or modules such as processor(s) 210, selection module 220, characteristics module 225, synthetic pool selection module 235, evaluation module 240, and/or components or modules. During receiving operation 910 a request to price servicing rights (e.g., to a mortgage portfolio) is received. Mortgage servicing rights, for example, are a contractual agreement where the right, or rights, to service an existing mortgage are sold by the original lender to another party (e.g., one who specializes in the various functions of servicing mortgages). The rights commonly include the right to collect mortgage payments monthly, set aside taxes and insurance premiums in escrow, and forward interest and principal to the mortgage lender. In exchange for these duties, the servicer receives compensation.

Determination operation 920 determines a set of characteristics of loans in the bid pool. These characteristics are used by selection operation 930 in selecting a static pool of loans from an active portfolio. In accordance with various embodiments, selection operation 930 may use various optimization algorithms and/or heuristics to find a best match or fit of loans from the active portfolio to the bid pool. Some of the characteristics may be weighted more than others. In addition, various metrics may be defined to measure a distance between the bid pool and the static pool. These metrics may be used to define certain minimum distance requirements.

Acceptance operation 940 determines whether the synthetic pool is acceptable. In some cases, acceptance operation 940 can use the metrics and minimum distance requirements. As an example, if a bid pool has number loans with a current balance over a specified amount (e.g., three hundred thousand), then acceptance operation 940 may only allow bid pools that have at least sixty percent or greater of the number of loans with a current balance over the specified amount to be allowed. In other cases, characteristics such as default rates, property types, loan types, and the like will also have to meet certain requirements or metrics.

If acceptance operation 940 determines that the synthetic pool is not acceptable, then acceptance operation 940 branches to selection operation 930 where the static pool is further refined. If acceptance operation 940 determines that the synthetic pool is acceptable, then acceptance operation 940 branches to pricing operation 950 where a price is determined for the servicing rights. Various models, assumptions, and factors (historical, current, and predictive) can be used in determining the pricing of the servicing rights. For example, prepayment speed, future mortgage rates, interest rate models, delinquency rates, default rates, local price trends, regional price trends, national price trends, and/or other factors may be used. These inputs may be derived from a historical analysis the synthetic bid pool which “closely” matches the bid data.

FIG. 10 is a flowchart illustrating a set of operations 1000 for generating strategies and performance reports in accordance with some embodiments of the present invention. As illustrated in FIG. 10, loan level bid data 1005 associated with a bid pool of loans is imported into a synthetic pool model during importation operation 1010. Identification operation 1015 identifies cohorts (e.g., a group of loans have a set of similar characteristics) material to the bid pool. The cohorts identified can depend on a variety of factors and objectives. For example, in some embodiments, a user may define liquidation strategies in definition operation 1020. These strategies can be used to define/identify characteristics of loans should be grouped together. Evaluation operation 1025 can evaluate the available data to define the groups (i.e., cohorts).

Once the cohorts have been identified, retrieval operation 1030 can retrieve active loan data associated with a loan servicer within a specified period. The active loan data and the bid data can be categorized by cohorts during categorization operation 1035. Matching operation 1040 matches the bid pool and potential pool by cohorts. In some cases, limiting operation 1045 can limit the number of potential pool loans. Then, creation operation 1050 creates an initial synthetic pool. A statistical profile of various characteristics can be generated during running operation 1055. Using the statistical profile, determination operation 1060 determines if the bid pool and the synthetic pool are comparable. If determination operation 1060 determines that the bid pool and the synthetic pool are comparable, then determination operation 1060 branches to reporting operation 1065 where one or more performance reports can be generated. If determination operation 1060 determines that the bid pool and the synthetic pool are not comparable, then determination operation 1060 branches to identification operation 1015 where the cohorts are modified.

FIG. 11 is a sequence diagram illustrating an example of the data flow between various components of a service performance analysis system in accordance with various embodiments of the present invention. As illustrated in FIG. 11, inventors can submit a bid pool of loans to an analyzer. The analyzer queries a portfolio database for loans serviced by a loan servicer which are similar to the bid pool. Information regarding the loans can be returned to the analyzer which generates a synthetic pool. A comparison between the synthetic pool and the bid pool is generated and submitted to an evaluator. The evaluator can determine a valuation on the MSR based on the comparison which is then submitted in a report to the investors. If any issues are detected with the comparison, then the evaluator requests that the analyzer generate additional synthetic pools for comparison with the bid pool.

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 12 is an example of a computer system 1200 with which embodiments of the present invention may be utilized. According to the present example, the computer system includes a bus 1210, at least one processor 1220, at least one communication port 1230, a main memory 1240, a removable storage media 1250, a read only memory 1260, and a mass storage 1270.

Processor(s) 1220 can be any known processor, such as, but not limited to, an Intel® Itanium® or Itanium 2® processor(s); AMD® Opteron® or Athlon MP® processor(s); or Motorola® lines of processors. Communication port(s) 1230 can be any of an RS-232 port for use with a modem-based dialup connection, a 10/100 Ethernet port, or a Gigabit port using copper or fiber. Communication port(s) 1230 may be chosen depending on a network such as a Local Area Network (LAN), Wide Area Network (WAN), or any network to which the computer system 1200 connects.

Main memory 1240 can be Random Access Memory (RAM) or any other dynamic storage device(s) commonly known in the art. Read only memory 1260 can be any static storage device(s) such as Programmable Read Only Memory (PROM) chips for storing static information such as instructions for processor 1220.

Mass storage 1270 can be used to store information and instructions. For example, hard disks such as the Adaptec® family of SCSI drives, an optical disc, an array of disks such as RAID, such as the Adaptec family of RAID drives, or any other mass storage devices may be used.

Bus 1210 communicatively couples processor(s) 1220 with the other memory, storage and communication blocks. Bus 1210 can be a PCI/PCI-X or SCSI based system bus depending on the storage devices used.

Removable storage media 1250 can be any kind of external hard-drives, floppy drives, IOMEGA® Zip Drives, Compact Disc—Read Only Memory (CD-ROM), Compact Disc—Re-Writable (CD-RW), and/or Digital Video Disk—Read Only Memory (DVD-ROM).

The components described above are meant to exemplify some types of possibilities. In no way should the aforementioned examples limit the scope of the invention, as they are only exemplary embodiments.

In conclusion, various embodiments of the present invention provide novel systems, methods and arrangements for mortgage portfolio evaluation. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations that fall within the scope of the claims, together with all equivalents thereof. Therefore, the above description should not be taken as limiting the scope of the invention, which is defined by the appended claims.

What is claimed:

1. A method comprising:
receiving a request to analyze a mortgage portfolio having a plurality of mortgages serviced by a first loan servicer;
identifying, using a processor, a set of loan characteristics of the mortgage portfolio;
creating, using the processor, a synthetic pool of mortgages based on the set of loan characteristics, wherein the synthetic pool of mortgages is created from mortgages being serviced by a second loan servicer; and
generating, using the processor, a performance analysis of the synthetic pool of mortgages.

2. The method of claim 1, wherein creating the synthetic pool of mortgages includes selecting loans serviced by the second loan servicer within a specified time period.

3. The method of claim 1, wherein creating the synthetic pool of mortgages includes evaluating the sample size of the synthetic mortgage pool.

4. The method of claim 1, wherein creating the synthetic pool of mortgages includes comparing the set of loan characteristics of the mortgage portfolio with the synthetic pool of mortgages.

5. The method of claim 1, further comprising calculating value groupings of the mortgage portfolio based on unpaid principle balance, current property value or current loan-to-value.

6. The method of claim 1, wherein the set of loan characteristics identified vary based on the size of the mortgage portfolio.

7. The method of claim 1, further comprising creating groupings of mortgages from the mortgage portfolio based on the set of loan characteristics.

8. The method of claim 7, wherein generating the performance analysis includes generating an individual analysis of each of the groupings.

9. The method of claim 1, further comprising receiving data regarding the mortgage portfolio that includes information about one or more of the following for each loan in the mortgage portfolio: lien position, current unpaid principal balance, current property value, current loan-to-value, current delinquency status, current interest rate, product type, property state, property zip code, occupancy type, or property type.

10. A system comprising:
a processor;
a historical servicing database having stored thereon a plurality information regarding servicing of a first plurality of loan mortgages serviced by a loan servicer, wherein the plurality of information includes mortgage characteristics;
an importation module configured to receive bid data regarding a second plurality of loan mortgages;
a characteristics module configured to access the bid data and identify a set of loan characteristics using the processor, wherein the loan characteristics are descriptive of the second plurality of loan mortgages;
a synthetic pool selection module configured to receive the set of loan characteristics and create, using the processor, a synthetic pool of loan mortgages by selecting a subset of the first plurality of loan mortgages similar to the second plurality of loan mortgages as defined by the loan characteristics identified by the characteristics module; and
a report module to generate an analysis of the synthetic pool.

11. The system of claim 10, wherein the loan mortgages are residential loan mortgages.

12. The system of claim 10, further comprising a grouping module to create subsets of the second plurality of loan mortgages based on mortgage characteristics.

13. The system of claim 10, further comprising an evaluation module to determine if the synthetic pool created by the synthetic pool selection module sufficiently matches the loan characteristics.

14. The system of claim 10, further comprising a graphical user interface (GUI) generation module configured to generate a first graphical user interface screen to present the analysis generated by the report module to a user.

15. The system of claim 10, wherein the synthetic pool selection module creates the synthetic pool of loan mortgages using an optimization algorithm.

16. A computer-implemented method comprising:
receiving a request to analyze a first residential mortgage portfolio having a plurality of residential mortgages;
importing, from a memory device, data related to the first residential mortgage portfolio into a synthetic pool model;
identifying, using a processor, cohorts material to the first residential mortgage portfolio and to a second residential mortgage portfolio;
creating, using the processor, a synthetic pool of mortgages by matching the cohorts of the first residential mortgage portfolio and the second residential mortgage portfolio; and
generating a performance analysis of the synthetic pool of mortgages.

17. The computer-implemented method of claim 16, wherein identifying the cohorts is based, at least in part, on a liquidation strategy.

18. The computer-implemented method of claim 16, further comprising retrieving active loan data regarding the second residential mortgage portfolio.

19. The computer-implemented method of claim 18, wherein the active loan data is limited to a specified time period.

20. The computer-implemented method of claim 16, further comprising determining if the synthetic pool of mortgages needs to be reselected based on a comparison of the first residential mortgage portfolio to the synthetic pool of mortgages.

21. The computer-implemented method of claim 16, further comprising generating a compensation recommendation for a set of mortgage servicing rights based on the performance analysis.
